(19) United States
(12) Patent Application Publication
(10) Pub. No.: US 2024/0416692 A1
(43) Pub. Date: Dec. 19, 2024

(54) SEMI-TRAILER TRUCK WITH FIFTH WHEEL WITH POWER-OPERATED CLOSURE

(71) Applicant: JOST-WERKE DEUTSCHLAND GMBH, Neu-Isenburg (DE)

(72) Inventor: Achim STRÜTT, Riedstadt (DE)

(21) Appl. No.: 18/740,031

(22) Filed: Jun. 11, 2024

(30) Foreign Application Priority Data
Jun. 15, 2023 (DE) 202023103325.3

(51) Int. Cl. B60D 1/01; B60D 1/62

(52) U.S. Cl. CPC B60D 1/015; B60D 1/62

(57) ABSTRACT

The invention relates to a semi-trailer truck with a tractor (10) and a semitrailer (12) having a kingpin, wherein the tractor (10) comprises a fifth wheel coupling (14) with a coupling plate (15), a closure for the king pin, an actuating mechanism for actuating the closure, and a cylinder-piston assembly (16) engaging the actuating mechanism for moving the actuating mechanism. The tractor (10) further comprises a compressed air supply line (18) to which the cylinder-piston assembly (16) can be connected directly by means of a quick coupling. The quick coupling is formed from a first and a compatible second coupling element (22, 24). The semitrailer (12) comprises a compressed air system, wherein the cylinder-piston assembly (16) and the compressed air system of the semitrailer (12) are each assigned the identical first coupling element (22, 24), and the compressed air supply line (18) is assigned the compatible second coupling element (20).

The invention relates to a semi-trailer truck with a tractor and a semitrailer with a kingpin, wherein the tractor (10) comprises a fifth wheel coupling (14), wherein the fifth wheel coupling comprises a fifth wheel coupling plate, a closure for the kingpin, an actuating mechanism for actuating the closure, and a cylinder-piston arrangement engaging the actuating mechanism for moving the actuating mechanism, wherein the tractor comprises a compressed air supply line and a cylinder-piston assembly for moving the actuating mechanism, wherein the tractor comprises a compressed air supply line and wherein the cylinder-piston assembly can be connected directly to the compressed air supply line of the tractor by means of a quick coupling.

Fifth wheel coupling plates are known to comprise an entry opening into which a kingpin of a semitrailer can be inserted and locked in its end position to form a mechanical connection for towing the semitrailer. In a known embodiment of the fifth wheel coupling, a locking hook pivotably mounted around a bearing pin is arranged under the fifth wheel coupling plate for locking, which is pivoted around the bearing pin into the entry opening against the force of a tension spring when the kingpin is coupled. Furthermore, an essentially translationally displaceable locking bar is arranged under the fifth wheel coupling plate, which then secures the locking hook against being turned back in its locked position, thus keeping it closed and arresting the kingpin. In the open position of the locking bar, it releases the locking hook, which swivels around the bearing pin when the kingpin is disengaged and clears the entry opening. In this embodiment, the closure hook and the locking bar together form the “closure” within the meaning of the description of the invention.

Furthermore, embodiments are known, for example, from the documents DE 94 01 718 U1 and CH 675 989 A5, in which the locking bar is displaced by means of a one-sided lever articulated thereto. A tension element is articulated to the free end of the lever, via which a torque is introduced into the lever. In this embodiment, the lever and the pulling element together form the “actuating mechanism” within the meaning of the description of the invention. The cylinder-piston assembly can act either on the pulling element or directly on the lever in order to move the locking bar. The cylinder-piston assembly acts in the direction of the open position of the locking bar, so that the closure can only be opened under pressure. If there is no pressure, the coupling between the kingpin and the fifth wheel is securely locked and accidental disengagement is impossible.

EP 1 162 090 B1 deals with a pressure fluid control for such a cylinder-piston arrangement, wherein the pressure fluid supply line is permanently connected to a pressure fluid source and comprises a shut-off valve which can be adjusted between a pass position and a shut-off position under the influence of a control medium. The actuating mechanism within the meaning of the invention is not limited to such an embodiment with a pulling element and lever. Nor is the closure limited to the embodiment described above with a locking hook and locking bar.

The closure to be opened by means of a cylinder-piston assembly is also referred to herein as a “power-operated closure”. Typically, the actuating mechanism also comprises means for manual handling. As is known, these are regularly designed as a handle arranged on the pulling element, which allows the actuating mechanism or the pulling element to be moved manually and thus also the closure or the locking bar to be moved from a locked position to an open position by a pulling movement against a spring force. Manual handling is available as a redundant actuation option if a cylinder-piston assembly is present, for example if the latter should fail.

As is known, the cylinder-piston assembly is connected to the compressed air supply of the tractor. The compressed air supply is controlled by an operator, for example from the driver's cab of the tractor, by means of a valve arrangement that can be actuated electromagnetically, for example. For safety reasons, high demands must be placed on the components used in order to avoid malfunctions. Some components must be duplicated to ensure their function. This applies in particular to the valves in order to prevent the closure from opening unintentionally in the event of a leak or malfunction of a valve with the highest possible level of safety. Furthermore, the actuation unit for the valves must be secured against accidental, incorrect or unauthorized operation. The safety precautions of such a power-operated closure therefore significantly increase the cost of the fifth wheel coupling.

It is therefore the object of the present invention to provide a fifth wheel coupling for a semi-trailer truck with a cost-effective power-operated closure.

The object is achieved in a semi-trailer truck with a tractor and a semitrailer of the type mentioned above in that the quick coupling is formed by a first and a compatible second coupling element, wherein the semitrailer comprises a brake system and a compressed air system for supplying the brake system, wherein the cylinder-piston assembly and the compressed air system of the semitrailer are assigned the identical first coupling element, and the compressed air supply line is assigned the compatible second coupling element. In this way, the compressed air supply line can be connected either to the compressed air system of the semitrailer in driving mode or to the cylinder-piston arrangement of the fifth wheel coupling in coupling mode.

A quick coupling is understood herein to be a media line coupling consisting of a first and a compatible second coupling element. The first and second coupling elements form a coupling pair and can be formed, for example, by plugs, plug sockets, coupling heads, sleeves or plug connectors. Quick coupling is therefore understood to mean any connection between two media lines that can be disconnected and joined repeatedly and without the use of tools.

“Directly” in this context means without the intermediate connection of valves. The quick coupling therefore functionally replaces the valve arrangement. If, for example, the plug and socket are manually inserted into each other, the cylinder-piston assembly is pressurized with compressed air. This is a simple way of preventing accidental operation.

The invention makes advantageous use of the fact that the tractor is already equipped with a compressed air supply line, for example a compressed air hose, for connection to the compressed air system of the semitrailer, for example for supplying the brake system. This connection is generally already made via a quick coupling. As this connection is not required when the semi-trailer truck (tractor with semi-trailer) is stationary, the driver can disconnect the compressed air supply line from the semi-trailer and connect it to the cylinder-piston assembly. It is therefore advantageous if the coupling element of the quick coupling on a semi-trailer truck, which is assigned to the cylinder-piston assembly, is identical in construction to the coupling element that is connected to the compressed air system of the semitrailer. Manual reconnection ensures that the closure can only be opened when the semi-trailer truck is stationary, so that accidental opening of the closure during a drive due to inadvertent or incorrect operation does not appear possible. This also makes unauthorized operation considerably more difficult.

Another advantage of this procedure is that the trailer is automatically braked by disconnecting it from the tractor's compressed air supply line and cannot roll away during coupling. As a rule, the semitrailers have spring-loaded systems that are only opened and held open by applying pressure against this spring force.

Preferably, the fifth wheel coupling comprises the first coupling element of the quick coupling, which is pneumatically connected to the cylinder-piston assembly by a line piece without the intermediate use of valves. The first coupling element is optionally a plug or a plug socket, a so-called coupling head, a sleeve, a plug connector or the like. The compatible second coupling element, i.e. the matching plug socket, the matching plug, coupling head, plug connector, sleeve or similar, is assigned to the compressed air supply line of the tractor.

The line piece makes it possible to position the first coupling element assigned to the fifth wheel coupling at a freely selectable point on the tractor. Together with the first coupling element, the line piece can also be arranged directly in or on a housing of the cylinder-piston arrangement.

Advantageously, the first coupling element is attached directly to the fifth wheel coupling or directly or indirectly to a frame part of the tractor, preferably in the vicinity of the fifth wheel coupling.

The former positioning allows a compact arrangement and requires only a short line piece. At the same time, the assignment of the first coupling element to the closure is clearer. The second positioning allows easier access for the operator. A retaining plate or a subframe, for example, can be provided as an indirect attachment to a frame part of the tractor.

Furthermore, the fifth wheel coupling preferably comprises a closure sensor which is arranged to output a closure signal when the closure is properly closed.

As already mentioned, the compressed air supply line, which preferably comprises a spiral hose, can be connected on the one hand to the compressed air system of the semitrailer, for example to supply the brake system in driving mode, or on the other hand to the cylinder-piston arrangement of the fifth wheel coupling to open the closure in coupling mode. In this way, it is not possible to open the closure accidentally while driving.

If the fifth wheel coupling comprises a locking sensor, the tractor also advantageously comprises a display device which is connected or can be connected to the locking sensor by wire or wirelessly and is arranged to display the locking signal.

Further details of the invention are explained in more detail below with reference to figures. The figures show:

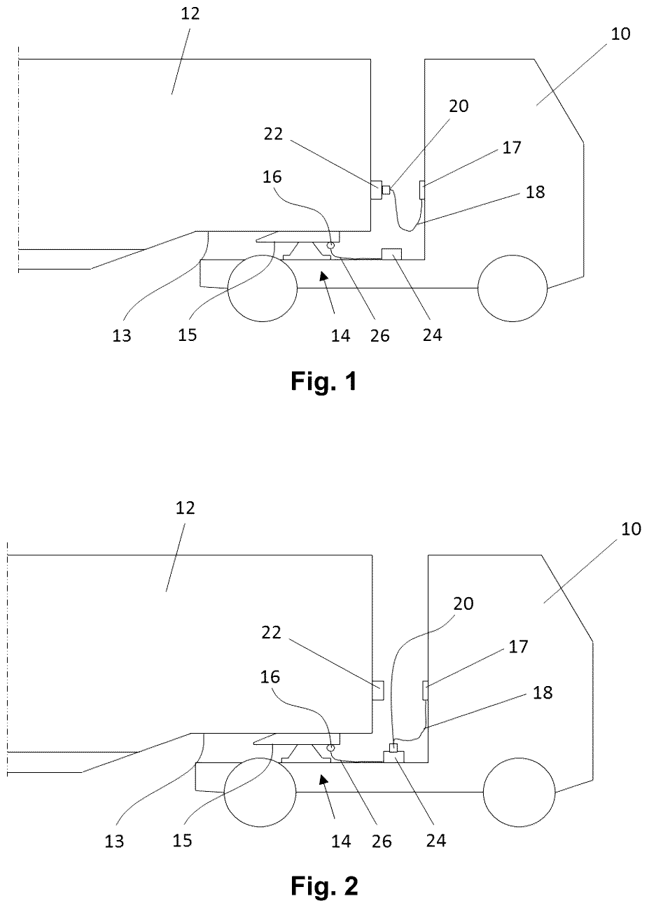

FIG. 1 a semitrailer combination in a ready-to-run condition;

FIG. 2 a semitrailer combination with the compressed air connection for opening the closure;

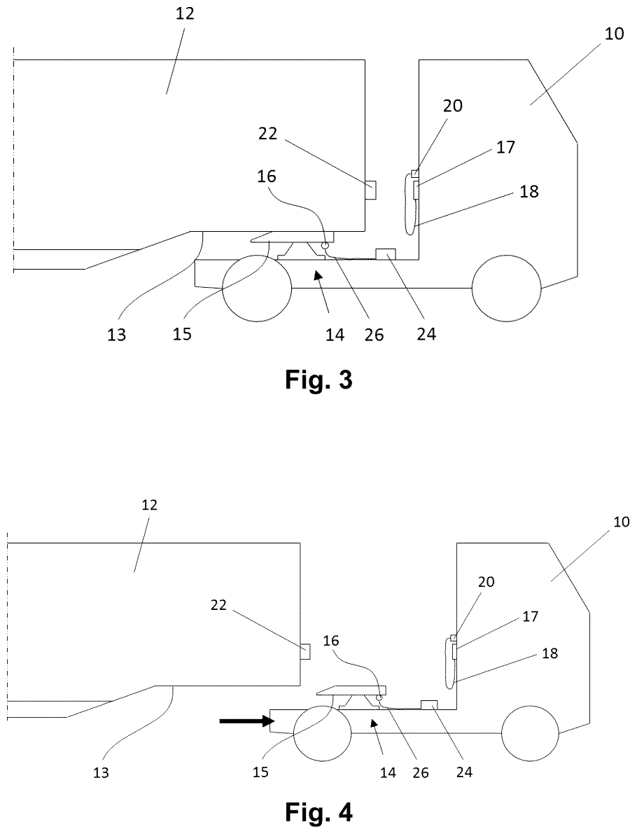

FIG. 3 a semitrailer combination arrangement ready for uncoupling;

FIG. 4 a tractor-trailer arrangement with the tractor uncoupled and

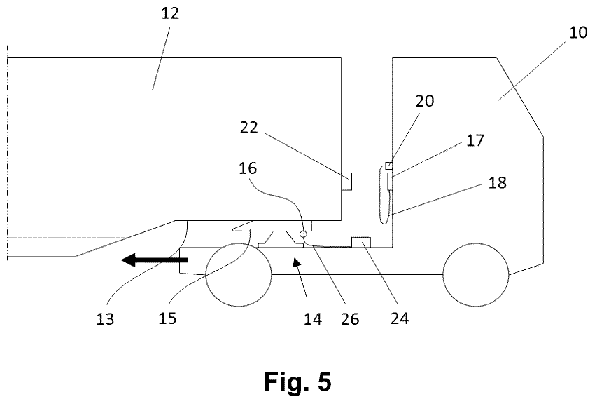

FIG. 5 a tractor-trailer arrangement with the tractor coupled again.

The semi-trailer truck consists of a tractor 10 and a semitrailer 12. In FIG. 1, the tractor 10 and the semitrailer 12 are coupled together ready to drive. The semitrailer rests with its base plate 13 on the fifth wheel coupling 14 of the tractor 10, wherein the kingpin (not shown) is locked in the end position of the entry opening of the fifth wheel coupling plate. Locking is carried out pneumatically by means of a cylinder-piston assembly 16, which is arranged below the fifth wheel coupling plate 15.

The tractor 10 comprises a compressed air supply, to which a compressed air supply line 18 is connected via an output-side compressed air connection 16 at the rear of the driver's cab. Such compressed air supply lines usually comprise a spiral hose. A second coupling element 20 is arranged at the free end of the compressed air supply line 18, for example in the form of a plug, a plug socket, a coupling head, a sleeve or a plug connector, which is connected to the compatible first coupling element 22 of the semitrailer truck 12 in the ready-to-run state of the semi-trailer truck shown here. The first coupling element 22 of the semitrailer is in turn connected to the compressed air system for supplying the brake system of the semitrailer 12.

In this way, the brake system of the semitrailer 12 is actuated by means of compressed air control in the tractor 10 during driving.

If the tractor 10 is to be uncoupled from the semitrailer 12, the connection between the second coupling element 20 of the compressed air supply line 18 and the first coupling element 22 of the semitrailer 12 is first disconnected manually and the second coupling element 20 of the compressed air supply line 18 is then manually connected to a first coupling element 24 of the fifth wheel coupling 14, which is attached to a frame part of the tractor 10, for example. By disconnecting from the compressed air supply line 18, the semitrailer is automatically braked and cannot roll away during the entire uncoupling process. The first coupling element 24 of the fifth wheel coupling 14 and the first coupling element 22 of the semitrailer 12 are identical in construction, so that no separate connecting hose with a different coupling element to the compressed air supply of the tractor 10 needs to be provided for the optional connection to the semitrailer 12 and the closure of the fifth wheel coupling 14.

The first coupling element 24 on the tractor 10 is permanently connected to the cylinder-piston assembly 16 by means of a line piece 26. There is therefore no switchable valve between the compressed air connection 17 on the output side of the tractor 10 and the cylinder-piston assembly 16 on the fifth wheel coupling 14. The compressed air supply is interrupted simply by disconnecting the second coupling element 20 from the first coupling element 24. In the state shown in FIG. 2, the cylinder-piston assembly 16 is therefore supplied with compressed air, whereby it opens the closure for the kingpin by means of the actuating mechanism. The semi-trailer truck is now ready to be uncoupled.

Before the tractor 10 drives away from the semitrailer 12, the second coupling element 20 on the compressed air supply line 18 can first be disconnected from the first coupling element 24 of the fifth wheel coupling 14, as the closure remains open for safety reasons immediately after opening, even if the cylinder-piston assembly 16 is depressurized. The closure is then in the so-called ready position, in which the actuating mechanism is mechanically held. The second coupling element 20 is shown here in its parked position directly at the rear of the cab of the tractor 10, where it is fixed by means of a suitable holder and the compressed air supply line 18 is safely stowed away. After these preparations, the tractor 10 can be driven away from the abutment 12. This process is illustrated in FIG. 4.

To re-couple, nothing more is required than to drive the tractor 10 back up to the semitrailer 12 in such a way that the kingpin comes to rest in the end position in the fifth wheel coupling plate, whereby the closure (not shown) closes by means of spring force and mechanically locks the kingpin securely. In order to make the semi-trailer truck ready to drive again, the second coupling element 20 on the compressed air supply line 18 is reconnected to the first coupling element 22 of the semitrailer 12, thus returning to the initial state shown in FIG. 1.

As an alternative to the variant shown in FIG. 4, the closure can also be left pressurized during driving away, as shown in FIG. 2. Even then, however, the second coupling element 20 on the compressed air supply line 18 must be disconnected from the first coupling element 24 at the latest when the semitrailer 12 is coupled again, so that the closure can close.

The individual steps of coupling and uncoupling are summarized again below:
Step 1: Pulling off the first coupling element 20 from the second coupling element 22 of the semitrailer 12 and inserting or connecting the first coupling element 20 into or to the second coupling element 24 of the fifth wheel coupling 14—the closure of the fifth wheel coupling 14 opens;
Step 2: Removing the first coupling element 20 from the second coupling element 24 of the fifth wheel coupling 14 and parking the first coupling element 20 in its parking position—the tractor 10 can drive away and
Step 3: Connecting the first coupling element 20 to the second coupling element 22 of the semitrailer 12 after the tractor 10 has been coupled again.

These steps 1 to 3 are carried out manually, so that no safety-relevant valve control is required. The processes are therefore user-friendly and at the same time inexpensive to implement.

### LIST OF REFERENCE SIGNS

10 Tractor
12 Semitrailer
13 Base plate
14 Fifth wheel coupling
15 Fifth wheel coupling plate
16 Cylinder-piston assembly
17 Compressed air connection
18 Compressed air supply line
20 Second coupling element
22 First coupling element of the semitrailer
24 First coupling element of the fifth wheel coupling
26 Line section

1. Semi-trailer truck with a tractor (10) and a semitrailer (12) having a kingpin, wherein the tractor (10) comprises a fifth wheel coupling (14), wherein the fifth wheel coupling (14) comprises a fifth wheel coupling plate (15), a closure for the king pin, an actuating mechanism for actuating the closure, and a cylinder-piston assembly (16) engaging the actuating mechanism for moving the actuating mechanism,
wherein the tractor (10) comprises a compressed air supply line (18), wherein the cylinder-piston assembly (16) can be connected directly to the compressed air supply line (18) of the tractor (10) by means of a quick coupling,
wherein the quick coupling is formed from a first and a compatible second coupling element (22, 24),
wherein the semitrailer (12) comprises a brake system and a compressed air system for supplying the brake system,
wherein the cylinder-piston assembly (16) and the compressed air system of the semitrailer (12) are each assigned the identical first coupling element (22, 24), and the compressed air supply line (18) is assigned the compatible second coupling element (20).

2. Semi-trailer truck according to claim 1, characterized in
that the fifth wheel coupling (14) comprises the first coupling element (24) of the quick coupling, which is pneumatically connected to the cylinder-piston assembly (16) by a line piece (26) without the interposition of valves.

3. Semi-trailer truck according to claim 2, characterized in
that the first coupling element (24) is attached directly to the fifth wheel coupling (14) or directly or indirectly to a frame part of the tractor (10), preferably in the vicinity of the fifth wheel coupling (14).

4. Semi-trailer truck according to one of the preceding claims, characterized in
that the fifth wheel coupling (14) comprises a closure sensor which is arranged to output a signal when the closure is properly closed.

5. Semi-trailer truck according to claim 4, characterized in
that the tractor (10) comprises a display device which is connected or can be connected to the closure sensor by wire or wirelessly and is arranged to display the signal.
